(19) United States
(12) Patent Application Publication
(10) Pub. No.: US 2009/0098265 A1
(43) Pub. Date: Apr. 16, 2009

(54) Method for production of masa

(75) Inventors: Thomas Kock, Sugar Land, TX (US); Peter Matthews, Katy, TX (US)

Correspondence Address: CRAIN, CATON & JAMES, FIVE HOUSTON CENTER, 1401 MCKINNEY, 17TH FLOOR, HOUSTON, TX, 77010, US

(73) Assignee: SATAKE USA, INC., Stafford, TX (US)

(21) Appl. No.: 11/870,812

(22) Filed: Oct. 11, 2007

(51) Int. Cl. A23L 1/10

(52) U.S. Cl. 426/481

(57) ABSTRACT

A method of producing masa which reduces the material and time required, including the amount of water required for processing, the amount of calcium and lime required, energy and space consumption, and processing time. The process preferably includes debranning the corn kernels, collecting the bran, subjecting the debranned corn kernels to a heated alkali solution, and milling the debranned corn kernels. The bran may be sifted and utilized for various products.

### CROSS REFERENCE TO RELATED APPLICATIONS

Not Applicable

### STATEMENT REGARDING FEDERALLY SPONSORED RESEARCH OR DEVELOPMENT

Not Applicable.

### BACKGROUND OF THE INVENTION

1. Field of the Invention

This invention relates generally to an improved method for production of masa, a dough for corn tortillas and the like, and in particular to preparation of corn kernels for a nixtamalized dough, which may be dried to flour.

2. Description of the Related Art

Corn tortillas and other products are typically produced from masa, a corn dough, and preferably from a dough produced from cooked corn. A corn kernel consists of three parts: the bran or pericarp, the germ, and the endosperm. The bran serves as the outer covering. The germ, if fertilized, will sprout into a new plant and contains healthy fats. The endosperm is the germ's food supply and contains starchy carbohydrates, proteins, vitamins and minerals.

Masa may be produced from nixtamal—corn which has been lime treated and partially cooked. Nixtamalization, the process of producing nixtamal from corn kernels, generally entails boiling hard, ripe corn kernels in water and lime and permitting the kernels to absorb some portion of the lime and water before removal from the remaining liquid, known as nejayote. The general process is well known, having been practiced by the Aztec and Maya. Nixtamalization provides several benefits, among them the introduction of calcium to the corn and therefore to the finished product, and the rendering of the niacin and several of the amino acids in corn more available to human metabolisms and thus providing protection against some deficiency diseases.

Historically, the whole corn kernel was cooked in a mixture of water and lime at a temperature near boiling. The corn was then allowed to steep in the lime water for a period of hours. The temperature and steep time were dependent, among other factors, upon the hardness of the corn and on the effort needed to cause the lime to penetrate, partially dissolve and loosen the bran of the corn kernel. The steeped corn kernels were then washed to further induce removal of bran and finally ground to masa, which may be immediately used or dried to flour. The extent of cooking, of steeping, and of cleaning depend on the particular recipe used.

During the nixtamalization process the corn kernels absorb water and leach various products. The nejayote must typically be treated thereafter to reduce environmental impacts. The nixtamal is thereafter milled to produce masa.

Various prior attempts have been made to prepare corn kernels for production of a masa with desirable properties or in a manner to reduce environmental impacts, including limiting the corn kernel components used for masa production, including masa production with or without traditional nixtamalization. Each has used one hundred percent of one or more available parts of the corn kernel.

Several patents teach milling the corn kernels into components and nixtamalization only of the bran to produce masa. U.S. Pat. No. 4,594,260 issued to Vaquiero teaches tempering of corn kernels, milling of the corn kernels, separation of the bran, nixtamalizing the bran only, mixing the nixtamalized bran with the germ and endosperm fragments, then milling the combination, U.S. Pat. No. 6,265,013 issued to Martinez-Montes also teaches milling of corn kernels and seperation of the bran from the endosperm and germ before nixtamalizion of the bran, but teaches milling the nixtamalized bran separate from the germ and endosperm and then recombining the milled components. U.S. Pat. No. 6,358,550 issued to Sanchez y de la Camara also teaches milling of corn kernels and separation of the components before nixtamalizing the bran, but also teaches milling the separated bran and milling the germ and endosperm before nixtamalization.

Some patents teach milling germ and endosperm without nixtamalizing to produce masa. U.S. Pat. No. 4,329,371, issued to Hart teaches tempering of corn kernels, then debranning the corn kernels in a water slurry cooking the debranned germ and endosperm via steam, and finally milling the endosperm and germ to form a masa without bran. Hart, however, teaches away from the use of lime or any other alkali in the production process. Similarly, U.S. Pat. No. 6,326,045 issued to Rubio et al teaches tempering of corn kernels, milling of the corn kernels, separation of the bran, drying of the germ and endosperm, milling of these two components to a flour, and finally combining this flour with lime to form a masa. Rubio thus teaches away from nixtamalization in favor of mixing lime into the flour.

Other patents teach masa production by milling the corn kernels and nixtamalizing the germ and endosperm or flours produced therefrom. U.S. Pat. No. 5,176,931 issued to Herbster, which recognizes the need for reduced nejayote, teaches steeping corn kernels in an alkali bath, debranning the kernels, partially cooking the debranned kernels via infrared radiation, and then milling the partially-cooked endosperm and germ to masa. U.S. Pat. No. 5,558,898 issued to Sunderland, which also recognizes the need for a low pollution method for preparing masa, teaches nixtamalization of whole kernels, removal of the bran, flash dehydrating the debranned kernel (germ and endosperm), then milling the debranned kernel to a flour. U.S. Pat. No. 6,818,240 issued to Brubacher et al teaches milling of the corn kernels, separation of the bran, milling the endosperm and germ to a flour, nixtamalizing the endosperm and germ flour, and then drying.

Some references, such as U.S. Patent 2006/0193964, inventor Eckhoff et al., alternatively teach milling the corn kernels and nixtamalization of endosperm only for masa production.

Finally, other references teach producing masa from bran, endosperm and germ. U.S. Pat. No. 6,025,011 issued to Wilkinson et al teaches tempering of corn kernels, milling of the corn kernels, and nixtamalization of all milled kernel components, which may be only germ and endosperm if the kernels are debranned before milling. Again, while these products receive some beneficial contribution of endosperm to the flour, because the endosperm is milled, an appreciable amount of the endosperm is lost in the nejayote. Patent Application Publication 2003-0198725, inventor Cardenas et al., teaches nixtamalization of the whole kernel, or non-fine fragments thereof, before milling the nixtamalized product, with or without un-nixtamalized product, to flour.

Some of the products produced by these methods of preparation of corn kernels lack entirely the beneficial contribution of endosperm to the flour, by excluding the endosperm from the milled product. Others only provide some of the beneficial contribution because the method of preparation of the corn kernels results in an appreciable amount of endosperm loss in the nejayote. Additionally, there is a sacrifice in these methods which retain the greatest beneficial contribution of the endosperm and which provide the lime-flavoring and cooking of the nixtamalization process. Specifically, these methods forego the opportunity to utilize unadulterated bran for other products. Finally, these substantial alterations of the corn kernel preparation process used to produce masa may require substantial alteration of existing processing plants.

A need therefore exists for a corn kernel preparation process used to produce masa which affords the opportunity to utilize unadulterated bran and/or germ and endosperm fragments for other products.

A need further exists for a corn kernel preparation process used to produce masa which affords the opportunity to nixtamalize a controlled amount of germ and endosperm fragments and/or bran with the unbroken debranned kernels.

A need further exists for a corn kernel preparation process used to produce masa which affords the opportunity to utilize a controlled amount of germ and endosperm fragments and/or bran which have not be nixtamalized.

A need exists for a nixtamalization plant which reduces material and time required, including the amount of water required for processing, the amount of alkali additives, (such as lime) required, energy and space consumption, and processing time.

Moreover, a need exists for a nixtamalization plant that reduces the contamination of water used in the nixtamalization process and therefore requires less treatment of the nejayote. Correspondingly, a need further exists for a nixtamalization plant that generates by-products with added value. Finally, a need exists to meet these needs without substantial renovation of existing processing plants.

### SUMMARY OF THE INVENTION

It is therefore a principle object of the present invention to provide a corn kernel preparation process which retains the highest beneficial contribution of endosperm to the masa, retains the lime flavoring and benefits of nixtamalization, reduces the material and time required for nixtamalization, and reduces the contamination of water used in the nixtamalization process and therefore requires less treatment of the nejayote. Correspondingly, this corn kernel preparation process produces a nixtamalization plant that generates by-products with added value. It is a further object of the present invention to permit nixtamalization of unbroken debranned corn kernels and of a controlled amount of bran and/or germ and endosperm fragments. It is a still further object of the present invention to permit production of masa from nixtamalized corn and unnixtamalized bran and/or germ and endosperm fragments.

The present invention comprises an improved method for preparation of corn kernels for production of masa wherein the corn kernels subjected to nixtamalization are already debranned but unbroken and which also captures the bran and the fragmented germ and endosperm in an unadulterated condition for use in other products. The bran is removed in a debranner from the whole corn kernels before nixtamalization and separated to a different product stream. The germ and endosperm fragments are removed by sifting after exiting the debranner. The unbroken debranned kernels are then nixtamalized before milling to masa.

The present invention also provides a further improved method where a controlled amount of bran and/or germ and endosperm fragments may be nixtamalized.

The present invention also provides a further improved method where a controlled amount of bran and/or germ and endosperm fragments may be includes with nixtamalized products for milling to masa.

The foregoing and other objectives, features, and advantages of the invention will be more readily understood upon consideration of the following detailed description of the invention, taken in conjunction with the accompanying drawings.

### BRIEF DESCRIPTION OF THE DRAWINGS

So that the manner in which the described features, advantages and objects of the invention, as well as others which will become apparent, are attained and can be understood in detail, more particular description of the invention briefly summarized above may be had by reference to the embodiments thereof that are illustrated in the drawings, which drawings form a part of this specification. It is to be noted, however, that the appended drawings illustrate only a typical preferred embodiment of the invention and are therefore not to be considered limiting of its scope as the invention may admit to other equally effective embodiments.

FIG. 1 depicts a process flow diagram of the typical method of processing corn kernels to produce masa.

FIG. 2 depicts a process flow diagram of the improved method of processing corn kernels to produce masa.

FIG. 3 depicts a debranning machine intended to remove the bran from corn kernels but otherwise retain the corn kernels in a substantially unbroken condition with minimal production of germ and endosperm fragments.

### DETAILED DESCRIPTION OF THE PREFERRED EMBODIMENT

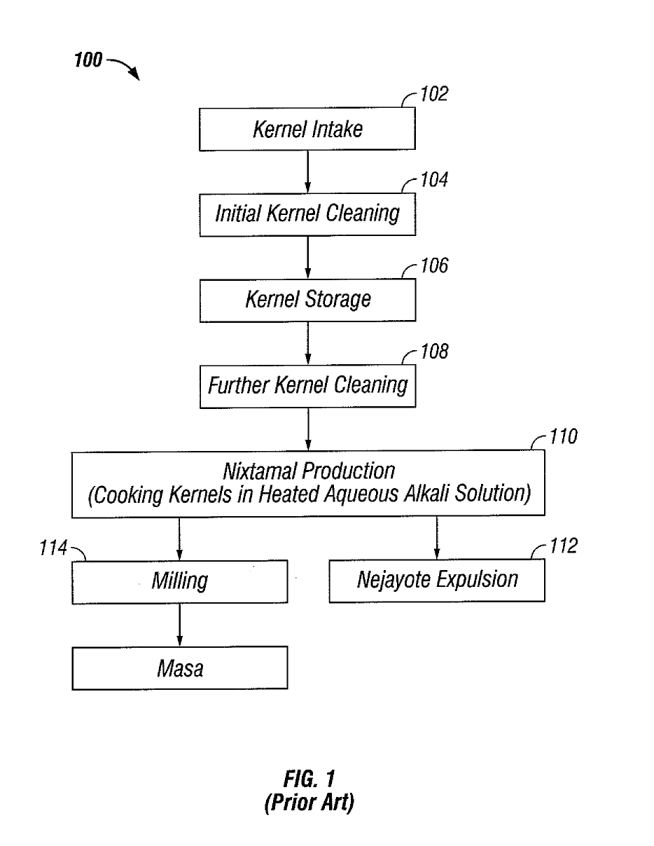

Referring first to FIG. 1, a process flow diagram of the typical method of processing corn kernels to produce masa is provided. The typical method 100 begins with a corn kernel intake 102 step, at which time corn kernels are introduced to the system. Typically such corn kernels have been removed from the cobs and foreign materials and unacceptable corn kernels removed. These acceptable corn kernels are then subjected to an initial kernel cleaning step 104 to remove any other dust, pollens, or surface debris. Various conventional cleaners are known for cleaning kernels. If the corn kernels are not to be immediately processed, the corn kernels may be subjected to a corn kernel storage step 106 in which the corn is stored in bins or silos. Immediately prior to use, particularly if the corn kernels have been stored, the corn kernels are subjected to a further corn kernel cleaning step 108. After cleaning, the corn kernels are typically subjected to the nixtamalizating step 110 wherein the corn kernels are cooked in water with lime. At the conclusion of the nixtamalizating step 110, the nejayote is expulsed at expulsion step 112. Finally, the nixtamalized corn kernels are subjected to a milling step 114 to be milled to masa.

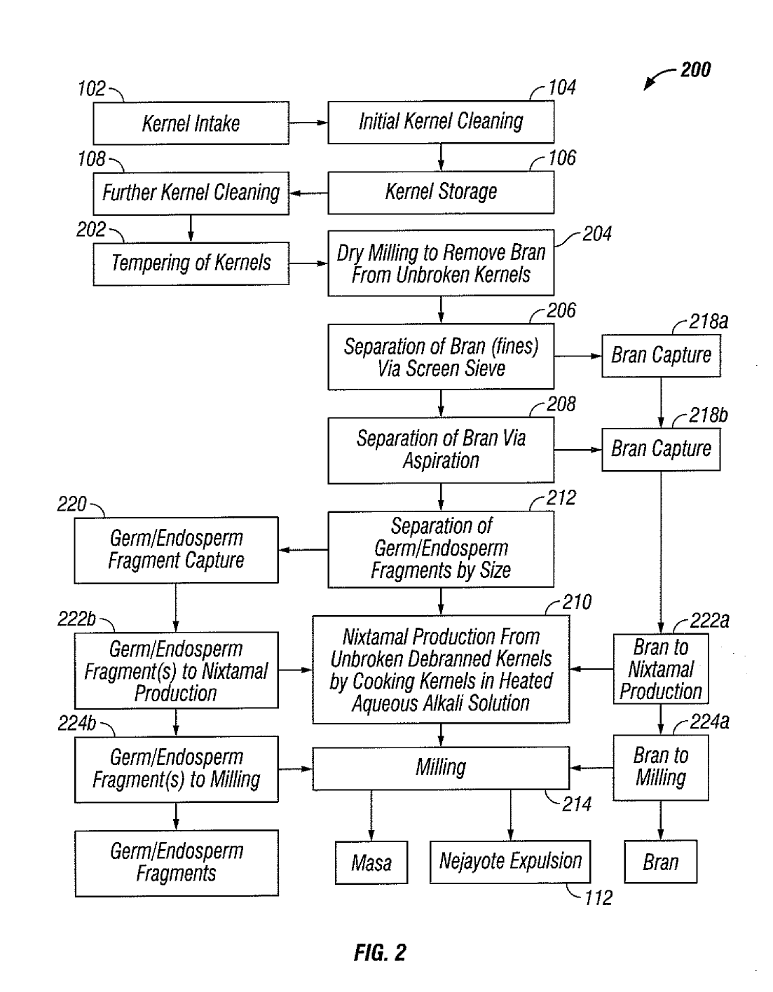

Referring to FIG. 2, the improved method 200 of processing corn kernels is disclosed. Unlike the prior art, the improved method of processing corn kernels provides for debranning substantially all kernels without appreciable fragmenting or breakage of the debranned corn kernels and for nixtamalization of unbroken debranned kernels.

This is accomplished by separating the bran from the whole kernels while maintaining substantially intact, or unbroken, the debranned corn kernels. As depicted in FIG. 2 the improved process may include a tempering step 202. It is known in the art to temper the corn kernels to be debranned by addition of a measured amount of water. Tempering permits control of the softening and expansion of bran layers while avoiding or limiting penetration of water into germ or endosperm. Absorption of water renders the layers of bran more pliable, and weakens the bond of bran to germ and endosperm The water may be in liquid or steam form, or may be combined with other chemicals. The corn kernels are then retained in a temper tank for a specific period of time to obtain the desired level of moisture absorption. Various tempering methods are known to produce the desired moisture absorption. At step 204, the tempered corn kernels are removed from the temper tank and subjected to a debranning machine for removal of the bran while maintaining substantially intact the debranned corn kernels. Thus only a small percentage of fragmented germ and endosperm, typically referred to as “brokens” is produced.

After debranning step 204, the unbroken debranned corn kernels are subjected to bran separation. Various methods are known for such separation, including screens 310 located in the debranner 300 for removal of fine particles (throughs) at step 206 or aspiration, step 208, in which air is introduced through the debranned corn kernels after the corn is removed from the debranner for removal of remaining fines and, more importantly, overtails which are too large to pass through any screens 310 which may be present. Regardless of the method used, the lighter bran and small fragments are separated from the heavier debranned corn kernels. Likewise almost all broken kernels, endosperm particles, and germ particles less than the desired size may be separated. Additionally, the debranned corn kernels may be sifted at step 212 to collect kernel fragments by size, leaving only substantially unbroken debranned corn kernels. These kernel fragments may be captured and collected 220. The bran, and any germ and endosperm particles, are then captured 218a, 218b and recovered and available for use in other products, such as standard flours and bran products.

The debranned and substantially unbroken kernels are thus available to be subjected to the nixtamalization step 210 wherein the debranned corn kernels are cooked in lime water. As the tough bran layer has been removed, the amount of lime or other alkali additive added to the water may be less than typically used. Likewise, the amount of time required for cooking and steeping of the corn kernels may be reduced as the time which previously was consumed in penetrating, partially dissolving and loosening the bran from the corn kernel has been eliminated. Some lime, however, may still added to the cooking water to season the taste of the debranned corn kernels.

In an alternative embodiment, a controlled portion of less than 100% of the kernel fragments and/or bran, may be combined at steps 222a and 222b with the debranned unbroken kernels for nixtamalization step 210 by a valve or other control. Unlike the prior art, which nixtamalized one hundred percent of the corn or its constituents, the present invention permits a specific amount of bran and/or fragments of germ and/or endosperm to be nixtamalized with debranned unbroken kernels.

The nejayote resulting from the nixtamalization step is still expulsed in step 112, but may be more environmentally friendly. Where the lime required during nixtamalization is reduced, the nejayote may be less alkaline and may therefore require less treatment for neutralization. Likewise, the use of substantially unbroken debranned corn kernels reduces the bran, endosperm and germ particles typically suspended in the nejayote and not available for milling and flour production. Moreover, this reduces the bran processed, which contains cellulose and may constitute some seven percent (7%) of intake. As a result, the amount of organic waste present in the nejayote and required to be addressed to comply with environmental regulations may be reduced and the cost to process the nejayote, typically quite expensive, may likewise be reduced.

Finally, the nixtamalized debranned corn kernels are subjected to the milling step 214 to produce masa. In a further alternative embodiment, a controlled portion of less than 100% of the kernel fragments and/or bran, may be combined at steps 224a and 224b with the unbroken debranned kernels for nixtamalization step 210 by a valve or other control. Unlike the prior art, which milled one hundred percent of the corn or its constituents, the present invention permits a specific amount of bran and/or fragments of germ and/or endosperm to be milled with nixtamalized unbroken debranned kernels.

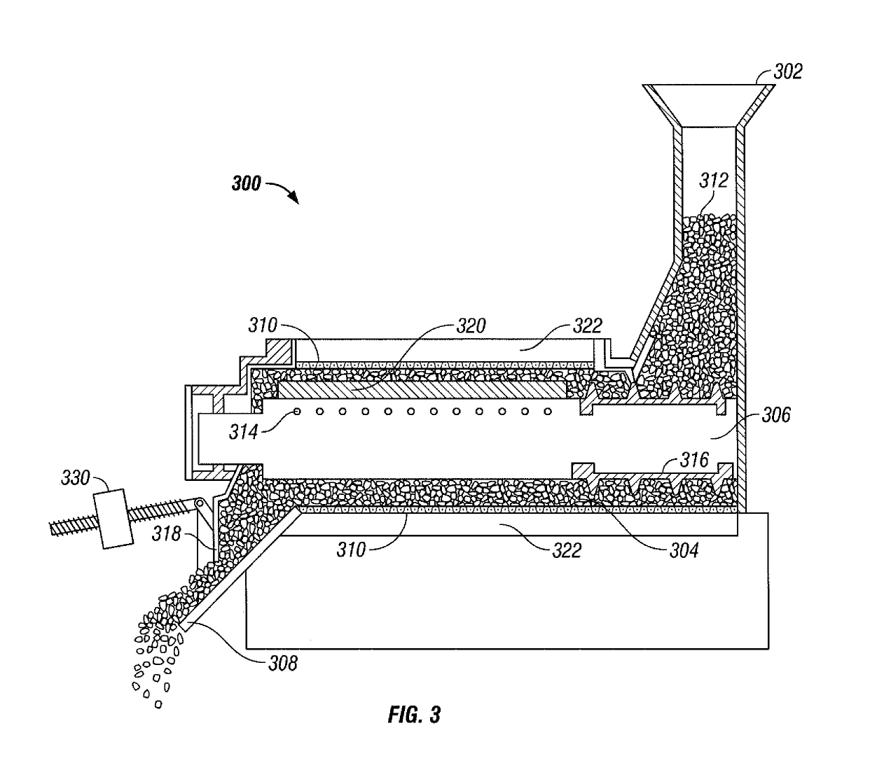

Corn milling machines are well known wherein whole and broken kernels are debranned by application of surface friction among the kernels to be milled. Such a debranning machine 300 is depicted in FIG. 3. Kernels 312, which may include broken kernels, may be supplied from a feed inlet 302 to a debranning chamber 304 having a roller 306, via feed screws 316. The kernels 312 are then circulated by the milling roller 306, and one or more protuberances or resistor bars 320 on its face, until exiting through a discharge 308. During circulation, kernels 312 press against one another thereby forcing tempered bran from surface of the various kernels 312. A perforated screen 310 may surround the debranning chamber 304 to permit particles, particularly fine bran, which are less than a particular size, to exit the debranning chamber 304 and further pressing against kernels 312 and forcing tempered bran away from the surface of the various kernels 312. The surface friction applied to each kernel by other kernels, the roller, and the screen 310 may also be affected by selection of the screen 310—which may retard kernels moving through the debranning chamber, induce kernels to move more rapidly through the debranning chamber, or have no effect on the speed at which the kernels pass through the debranning chamber. Roller 306 may include perforations 314 for aspirating kernels 312. The force and time of debranning may be controlled by requiring a minimum force be applied to a discharge gate 318 by or through the adjacent kernels to overcome a predetermined force 330, typically a weight, externally applied to the gate 318. The bran moving through screen 310 may be captured in one or more sections 322 surrounding milling chamber 304.

The foregoing disclosure and description of the invention is illustrative and explanatory thereof Various changes in the details of the illustrated process may be made within the scope of the appended claims without departing from the spirit of the invention. The present invention should only be limited by the following claims and their legal equivalents.

We claim:

1. An improved method for preparation of unbroken corn kernels for production of nixtamal, said unbroken corn kernels having bran, comprising the steps of:
tempering said unbroken corn kernels in water for sufficient time for said bran to be softened;
removing said bran from said tempered unbroken corn kernels by applying surface forces to said tempered unbroken corn kernels, said unbroken debranned corn kernels remaining substantially unbroken;
separating said bran from said unbroken debranned corn kernels; and
retaining said unbroken debranned corn kernels.

2. The improved method of claim 1, wherein said step of separating said bran from said debranned corn kernels comprises:
permitting an appreciable amount of said bran to escape said debranner through at least one screen sieve.

3. The improved method of claim 1, wherein said step of separating said bran from said unbroken debranned corn kernels comprises:
permitting an appreciable amount of said bran to escape said debranner through at least one screen sieve; and
capturing said bran escaping said debranner through said at least one screen sieve.

4. The improved method of claim 1, wherein said step of separating said bran from said unbroken debranned corn kernels further comprises:
permitting an appreciable amount of said bran to escape said debranner through at least one screen sieve;
capturing said bran escaping said debranner through said at least one screen sieve;
aspirating said unbroken debranned corn kernels for separation of said bran; and
capturing said bran aspirated from said unbroken debranned corn kernels.

5. The improved method of claim 1, wherein said step of separating said bran from said unbroken debranned kernels comprises:
aspirating said unbroken debranned corn kernels.

6. The improved method of claim 1, further comprising:
aspirating said unbroken debranned corn kernels; and
capturing said aspirated bran.

7. An improved method for production of masa:
tempering unbroken corn kernels in water for sufficient time for the bran of said unbroken corn kernels to be softened;
removing said bran from said unbroken corn kernels by applying surface forces to said tempered unbroken corn kernels, said unbroken debranned corn kernels remaining substantially unbroken;
separating said bran from said unbroken debranned corn kernels;
retaining said unbroken debranned corn kernels;
nixtamalizing said unbroken debranned corn kernels; and
milling said nixtamalized unbroken debranned corn kernels to masa.

8. The improved method of claim 7, further comprising:
capturing said separated bran.

9. The improved method claim 7, further comprising:
capturing said separated bran;
nixtamalizing less than one hundred percent of said separated bran with said unbroken debranned corn kernels; and
milling said nixtamalized bran less than one hundred percent with said nixtamalized unbroken debranned corn kernels.

10. The improved method of claim 7, further comprising:
separating any broken corn kernels from said unbroken debranned corn kernels; and
capturing said broken corn kernels.

11. The improved method claim 7, further comprising:
separating any broken corn kernels from said unbroken debranned corn kernels;
capturing said broken corn kernels;
nixtamalizing less than one hundred percent of said broken corn kernels with said unbroken debranned corn kernels; and
milling said nixtamalized broken corn kernels with said nixtamalized unbroken debranned corn kernels.

12. The improved method claim 7, further comprising:
capturing said separated bran; and
milling less than one hundred percent of said bran with said nixtamalized unbroken debranned corn kernels.

13. The improved method claim 7, further comprising:
separating any broken corn kernels from said unbroken debranned corn kernels;
capturing said broken corn kernels; and
milling less than one hundred percent of said broken corn kernels with said nixtamalized unbroken debranned corn kernels.

14. The improved method claim 7, further comprising:
capturing said separated bran;
separating any broken corn kernels from said unbroken debranned corn kernels;
capturing said broken corn kernels;
nixtamalizing less than one hundred percent of said separated bran with said unbroken debranned corn kernels;
nixtamalizing less than one hundred percent of said broken corn kernels with said unbroken debranned corn kernels; and
milling said nixtamalized bran and said nixtamalized broken corn kernel with said nixtamalized unbroken debranned corn kernels.

15. The improved method claim 7, further comprising:
capturing said separated bran;
separating any broken corn kernels from said unbroken debranned corn kernels;
capturing said broken corn kernels and
milling less than one hundred percent of said bran and less than one hundred percent of said broken corn kernel with said nixtamalized unbroken debranned corn kernels.
